(19) United States
(12) Patent Application Publication
(10) Pub. No.: US 2004/0016175 A1
(43) Pub. Date: Jan. 29, 2004

(54) Lethal capsule method for killing organsims

(76) Inventor: James W. Nielsen, Brookings, OR (US)

Correspondence Address: James W. Nielsen, P.O. Box 6669, Brookings, OR, 97415, US

(21) Appl. No.: 10/206,412

(22) Filed: Jul. 29, 2002

(51) Int. Cl. B64D 1/04; F41F 5/00; A01C 1/00; A01G 1/00

(52) U.S. Cl. 47/1.5; 89/1.11

(57) ABSTRACT

A method of killing organisms such as an individual living thing as a person, animal or plant such as brush, weeds and unwanted plants on terrestrial terrain by selecting hollow capsules formed by a frangible or non-frangible membrane, filling such capsules with respective charges of chemicals known and register by the U.S. Environmental Protection Agency, and labeled as liquid, fluid, solid powder, granules or gas of the type to which such organisms are susceptible to provide a supply of such charged capsules. Selecting a repeater capsule firing gun of the type incorporating a mechanism having sufficient propulsion to transmit a certain minimum muzzle velocity to such capsules in a repetitive manner, transporting such guns by automobile, truck, human or animals over such terrain. Shooting a quantity of such capsules at each organism from a range sufficiently close to cause the organisms to tear open and rupture upon impact to thereby penetrate and deposit the lethal toxin into the organisms.

### DESCRIPTION OF PRIOR ART

An organism such as an individual living thing as a person, animal, or plant are well known. Organisms such as unwanted plants, brush, weeds and the like have had an enormous economic effect which has caused low crop production. Policing and environmental regulations are also costly for the acceleration of contamination of the agriculture and food supply. Efforts by U.S. Agriculture, U.S. Environmental Protection Agency, State agencies and landowners to spray pesticides on unwanted plants have lead to numerous and different methods of control.

Many method of killing terrestrial organisms have existed for thousands of years. Lighting strikes and sparks a fire which burns the forest and prairie. Human inhabitants used fire to burn large areas so that new growth will emerge from the soil. The ancient people didn't realize at the times that fires killed the good organisms with the bad.

Another conventional approach, particularly for unwanted brush and weeds is the method of hand pulling manually attacking brush and weeds is laborious and time consuming by pulling each unwanted plant one by one. Another approach is spraying pesticide liquids over a broad areas by non-selective or selective broadcast spraying with the use of aircraft, trucks and/or by hand held tank sprayers. The method of liquid spraying is popular and although it is broadcasting will target the good plants as well as the unwanted brush and weeds. A side effect of spraying liquids are that the winds can cause chemicals materials to drift out side the target area and spray ingredients residue may flow in the soil outside the target area.

Another conventional approach is the use of granule pesticides. Granules formulated with NPK (nitrogen, phosphate and potassium) are formulated with Sevin, (Carbaryl) and labels with Glyphosate are uses of Weed and Feed and Insecticides. Some formulas are well known and others have problems with killing the unwanted as well as the good plants, insects and microorganisms. Granule dust application can be carried by wind and can move through the sub surface of the soil to outside the target area.

Another system for delivering pesticides at precised location is U.S. Pat. No. 5,174,807. This invention contemplates the use of a pressurized gun to impel frangible herbicides charged balis from a vehicle such as a helicopter to impact the stems or branches of plants to cause the balls to burst, thus splashing the herbicide Round up (R) Glyphosate on to the leaves of the plants. Moreover, the dwell time is expensive for a helicopter hovering over a crop of unwanted drug plants.(marijuana)

Another system for delivering a pesticides is U.S. Pat. No. 2001/0054367 A1. A projectile that must be turned around for the purpose of long distance shooting and reversed projectile for close delivery spraying. The invention relates to a method of use of the subject system that causes the projectile to separate differently, depending upon the orientation of the projectile relative to the direction of travel when launched. The invention teaches to disperse a control agent around the target or within the target area.

Another system for delivering a paint ball is U.S. Pat. No. 5,639,526. The invention relates to fragile projectile and methods for forming the same which are typically fired by compressed gas guns. The invention relates to projectile structures formed by an outer shell that fractures in a predetermined pattern to disperse paint contained therein. The invention is made to fall apart and disperse on contact to a target.

Thus there exist a need for a effective method for delivering measured quantities of a lethal toxin at relatively precise locations on the target plants to be controlled to thereby provide for effective delivery in quantities at pinpointed locations in organisms such as unwanted plants.

The present invention contemplates the use of a pressurized gun to penetrate frangible and non-frangible pesticides charged capsules from a application device to rip open the sterns and branches of a plant to cause the capsules to burst inside the plants depositing lethal toxins.

Pressurized guns and frangible and capsules containing liquid dyes have long been known for use in paint balls games wherein contestants shoots the balls at a velocity which will, while avoiding impact on the person of the competitor with sufficient force to cause undue pain or injury, win cause the ball skin to burst to splash the contained dye paint on the person thus creating a mark to identify the loser of the game. The method of using such guns is not, however, satisfactory for controlling unwanted brush and weeds. More over, the skin membrane of such paint balls is typically without sufficient strength to withstand the relatively high muzzle velocities which must be imparted to the herbicide balls for the desired accuracy and impact forces necessary to assure bursting of skin membrane upon impact.

It has also been known to utilize a pressurized gun to deliver a marker pellet to be used as a marker for marking the trunks of trees to be thinned from a forest. These guns are, however, typically intended for close range application thus requiring only low muzzle velocity and the pellets typically employ membrane skin which bursts under relatively modest forces substantially less than the comparatively high forces imposed by the high muzzle velocities necessary for proper operation of the lethal toxin charged capsules of my invention.

### SUMMARY OF THE INVENTION

The present invention is characterized by the selection of frangible or non-frangible spherical capsule skins, filling such capsule skins with charges of toxins, armed with a hand held repeating pressure gun and locating the site of unwanted organisms such as brush and weeds. Then, while holding the gun, the capsules are shot from the gun at a sufficiently close range and with sufficient velocity to the balls to be directly penetrate and tear into the stems of the unwanted organisms to cause the skins thereof to burst inside the stems and the contained toxins to release the lethal toxins into the plants.

Other objects and features of the invention will become apparent from consideration of the following description taken in connection with the accompanying drawings.

### BRIEF DESCRIPTION OF THE DRAWINGS

FIG. 1 is a perspective view of a pressurized gun which my be utilized in the lethal toxin delivery method of the present invention;

FIG. 2 is a front elevational view of an lethal toxin containing capsule utilized in the method of the present invention;

FIG. 3 is a elevational view, in reduced scale, of the capsule shown in FIG. 2 as it rips into the stem of a unwanted organism;

FIG. 4 is a vertical sectional view, enlarged scale of the capsule shown in FIGS. 2 AND 3 after it rips into the stem of an unwanted organism;

FIG. 5 is a vertical sectional view enlarged scale of the interior of FIGS. 3 AND 4;

FIG. 6 is a vertical sectional view enlarge scale of the FIG. 2 impact and tearing inside of unwanted stem organism effects over a ten day period of time.

### DETAILED DESCRIPTION OF THE PREFERRED EMBODIMENT

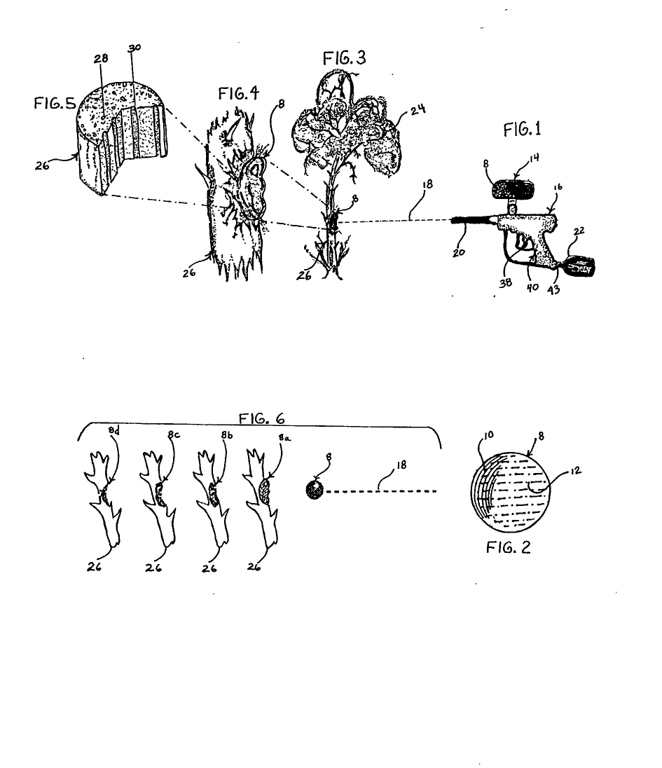

Referring to FIGS. 1, 2, 3, 4 AND 6 the method of the present invention selecting a skin 10 for a hollow capsule, generally designated 8, filling such skin with lethal toxin compounds 12 incorporating a dye and a sticking agent, and storing a supply of the charged capsules in a magazine 14 for discharge via a pressurized gun, generally designed 16. The gun 16 is typically hand held and transported to targets and actuated to drive the capsules 8 along a pathway 18 into the stem of the unwanted organism which may be in the form of brush 24. The muzzle velocity of the capsules 8 from the gun 16 is sufficient that, at the distance of deliver, the skin 10 of the capsule will burst thus causing the toxins 12 to rip open inside the stems of the plants thereby entering the vascular system 28 and 30 of such stems and killing the plants.

I have determined that the capsules skin 10 made from plastic and a gelatin, and sold under the designation Proball and having a thickness of between 0.015 and 0.020 inches is satisfactory for the present invention. It is important that the strength of the skin be sufficient to withstand the high forces imported thereto upon propulsion from the muzzle 20 of the gun 16 at a velocity of at least 350 feet per second a frangible to burst upon penetration inside the stem 26 of a unwanted organism such as brush plant 24.

I have discovered that by intermixing lethal toxins in a plastic gelatin skin 10 having sufficient strength to withstand muzzle velocities imparted by the gun 16 on the order of 350 to 450 feet per second, and shooting such capsules from the gun in muzzle velocities of over 350 feet per second, the capsules may be efficiently and effectively delivered with acceptable accuracy over distances on the order of 10 to 150 feet or more to thereby provide for efficient and effective application of lethal toxins.

In my preferred embodiment, I utilize a conventional pressure gun 16 available from the Avenger Brass Eagle Co., Roger, Ariz., under Model No. 68 Caliber. The gun is semiautomatic, firing 300 rounds per minute and has been modified to raise the muzzle velocity from about 300 feet per second to between 350 to 450 feet per second.

The lethal toxin 12 is preferable in a liquid formulation and sold under the trade name Brush Block by Greenergy, Inc. and can be intermixed with Glosphate in Round Up by Monsantos and 2,4-D Triclopyr in Crossbow by Dow Chemical and others listed by the U.S. Environmental Protection Agency.

The gun 16 incorporates the usual barrel 20 FIG. 1 hand carried amount of lethal toxin filled capsules 8 from a magazine 14. Prompting thereof is controlled by a trigger 38 and in a pistol grip assembly generally designated 40. The gun is hand held and incorporating an attached CO2 pressurization tank 22 FIG. 1 connected thereto by means of an attached conduit 43.

In operation the capsules will be manufactured by filling the skins 10 with the lethal toxins fluid 12 to provide the ball diameter corresponding with the 68 caliber barrel 20 of gun 16. The capsule may then be stored ready for target usage.

When a crop of unwanted organisms such as brush or weeds, listed with the U.S. Environmental Protection Agency, plants 24 shown in FIG. 3, the gun 16 will be positioned such that the operator may fire the gun at the target site. A supply of capsules 8 will be carried in the magazine 14 filled in preparation for application of the lethal toxin. Position for the target and the gun operator will aim gun 16 at unwanted organism 24. By then pulling the trigger 38, the capsules will be discharged at the rate of about 300 per minute.

Upon penetration of the capsule 8 with the plant stems, as depicted in FIGS. 6, 3 and 4 sufficient penetration forces will be generated to rip open the surface of the plants stem 26 thereby abruptly injecting the charge of lethal toxins 12 inside the plants stem It is important that the capsules 8 penetrate the stem 26 of the plant to deposit 12 inside the plants FIGS. 3 AND 4 to enter into the xylem 28 and the phloem 30 and through the organisms vascular system FIG. 5. Typically approximately 1 to 2 capsules are penetrated into each organism 24 to thus assure effective distribution of the lethal toxin to assure complete deaths of the organisms.

From the forgoing, it will be appreciated that the method of the present invention provides aft economical, convenient and effective means for application of a toxin to unwanted organisms.

Various modification and changes maybe made with regard to the foregoing detailed description without departing from the spirit of the invention.

What is claimed is:

1. A method for the precision application of measured amounts of lethal toxins to organisms including the following steps:
selecting toxins of the type to which such organisms are susceptible:
selecting a supply of hollow capsules formed by frangible skins;
filling said capsules with predetermined charges of such toxins to form charged capsules;
selecting a repeating powered gun for shooting said capsules from said supply, said gun being of the type having a propulsion mechanism adapted to respetitively deliver a selected propulsion force to said charged capsules to generate a muzzle velocity of at least about 350 feet per second;
said capsules being selected with skins having sufficient strength to, when charged with said charges of toxins, upon application of said selected propulsion force, resist breaking but to upon striking the body of the organism with a predetermined velocity, penetrate;
transporting said gun and supply of charged capsules to the proximity of said organsims;
aiming said gun sequentially at different organsims from a selected distance sufficient to cause said capsules to, when fired from said gun, be propelled along a projectile path to the respective targeted organsim to penetrate said bodies with said predetermined velocity; and
firing a selected portion of said supply of capsules at each organism to be lethal causing said capsules to penetrate into the body of the respective organsim of the target organism striking such bodies thereof to penetrate tearing open said skin causing said toxin into the bodies enhancing absorption of such toxins.

2. A method as set forth in claim 1 where in: said distance is selected to be between 10 and 150 feet.

3. A method as set forth in claim 1 adapted for destroying organsims including any individual living thing, whether plant or animal and includes the step of:
charging said capsules with mixtures of said toxin and dye;
selecting said gun with sufficient muzzle velocity to, when shooting said capsules from said selected distance, cause them to rip open penetrate respective organism depositing toxins into organism, in addition to applying said toxins, apply said dye to mark the target treated by said toxin.

4. A method as set forth in claim 1 wherein:
said capsules are selected as 68 caliber in size; and said gun is selected for shooting 68 caliber capsules.

5. A method of destroying organisms as set forth in claim 1 that includes:
said step of transporting said gun and supply of charged capsules includes the selection of any movement for transit.

6. A method of destroying organsims as set for in claim 1 wherein:
said selection of said capsules includes the step of selecting said capsules with a skin construction of gelatin having a thickness of at least 0.015 inches.

7. A method as set forth in claim 1 wherein:
said gun is selected to deliver substantially 300 capsules per minute.

8. A method as set forth in claim 1 wherein:
said selected distance is selected to be between 10-200 feet.

9. A method as set forth in claim 1 wherein:
said selected distance is selected to be at least 10 feet

10. A method as set forth in claim 1 that includes the step of:
operating said gun to impact at least one or more capsules on each such target organism.

11. A method as set forth in claim 1 wherein:
said capsules are selected with gelatin skins having a thickness of between 0.015 and 0.020 inches.

12. A method as set forth in claim 1 wherein:
said gun is selected to establish said muzzle velocity at between 350 and 450 feet per second.

13. A method as set forth in claim 1 for targeting of organisms and wherein:
said step of selecting toxin includes the selection of antibiotic.

14. A method as set forth in claim 3 wherein:
the selection of said mixture includes the step of selecting it with a sticking agent to cause the mixture to stick to the area of such organisms targeted with said charged capsules.

15. A method of precisely appling measured amounts of toxins to organisms therein, including the following steps:
selecting a lethal toxin to which said organisms are susceptible;
selecting hollow capsules constructed of skin frangible and non-frangible at a predetermined bursting force and formed of a predetermined outside diameter;
charging said capsules with measured charges of said toxin to provide charged capsules each having a predetermined weight;
selecting a gun for shooting said charged capsules at a predetermined muzzle velocity;
transporting said gun and charged capsules to the proximity of such organsims to be treated;
mounting said gun in a vehicle or non vehicle to travel near said organisms at a predetermined distance therefrom;
aiming said gun continuously at targeted organism firing a selected number of charged capsules at said organism;
said skin of said capsules being of material selected with sufficient strength to withstand the force of said muzzle velocity and said predetermined distance being selected to cause said capsules to, when fired from said predetermined muzzle velocity, penetrate at least some of such bodies and tearing bodies thereof with sufficient velocity to apply said predetermined penetrating force to the respective bodies there of to cause the respective capsules to rip open and deposit.
